(19) United States
(12) Patent Application Publication
(10) Pub. No.: US 2010/0046258 A1
(43) Pub. Date: Feb. 25, 2010

(54) POWER SUPPLY CONTROL SYSTEM

(75) Inventors: David Robert Coulson, Bedfordshire (GB); Philip John Moyse, Bedford (GB)

Correspondence Address: KNOBBE MARTENS OLSON & BEAR LLP, 2040 MAIN STREET, FOURTEENTH FLOOR, IRVINE, CA, 92614, US

(73) Assignee: CAMBRIDGE SEMICONDUCTOR LIMITED, Cambridgeshire (GB)

(21) Appl. No.: 11/722,513

(22) PCT Filed: Dec. 13, 2005
(86) PCT No.: PCT/GB2005/050244

§ 371 Date: Nov. 12, 2009

Related U.S. Application Data
(60) Provisional application No. 60/646,890, filed on Jan. 25, 2005.

(30) Foreign Application Priority Data
Dec. 21, 2004 (GB) 0427893.3

(51) Int. Cl. H02M 3/24

(52) U.S. Cl. 363/95

(57) ABSTRACT

A digital control system for a switch mode power supply (SMPS), the control system having a demand input for a signal indicating whether an output voltage of said SMPS is above or below a desired value, and a drive output for a switch controlling energy transfer between an input and an output of said SMPS during a power switching cycle, the control system further including: a signal processor coupled to said demand input and to said drive output to control said drive output responsive to said demand signal to regulate said output voltage at said desired value, and wherein said signal processor includes at least one storage element to store at least one value of said demand signal, and wherein said switching control signal for a said power switching cycle is responsive to a value of said demand signal in at least two previous power switching cycles.

This invention relates to methods and apparatus for controlling switch mode power supplies, in particular digitally on a per-power-switching cycle basis. A preferred embodiment of the present invention is referred to by die inventors as “RightBrane”.

A generalised switch mode power supply comprises an energy transfer device for transferring energy cyclically from an input to an output of a power supply (in a flyback regulator design), a switching device coupled to the input of the power supply and to the energy transfer device, and a control system for controlling the switching device in response to a feedback signal to regulate the output voltage of the power supply by regulating the energy transferred per cycle. The switch has two states, a first state in which energy is stored in the energy transfer device, and a second state for transferring the stored energy to the power supply output. Typically the energy transfer device comprises an inductor or transformer and the switching device is controlled by a series of pulses, the transfer of power between the input and the output of the power supply being regulated by either pulse width modulation or pulse frequency (period) modulation. The data sheet for the iWatt iW2201 power supply controller also describes pulse “density” or rate modulation (which is similar to pulse frequency modulation).

There are many ways of deriving a feedback signal for the control system to regulate the power supply—for example, direct feedback from the power supply output may be employed, generally in this case employing some form of isolation between the output and input such as an opto-isolator or pulse transformer. Alternatively, if a transformer is used as the energy transfer device, an additional or auxiliary winding on the transformer can be used to sense the reflected secondary voltage, which approximates to the power supply output voltage.

The (rectified) input voltage can be switched across the energy transfer inductor or transformer at a much higher frequency than 50 Hz or 60 Hz mains, typically from tens of kilohertz up to megahertz, thus providing additional advantages of switch mode power supplies, reduced size and increased efficiency. Furthermore the skilled person will know that switch mode power supplies may be used to either step up or step down a DC input voltage and/or to reverse its polarity.

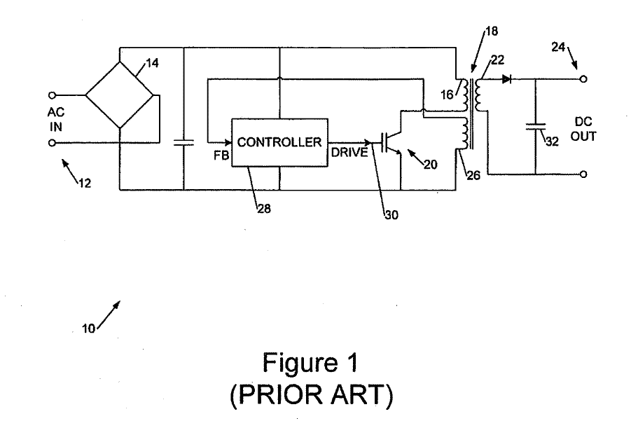

In this document we will describe an improved switch mode power supply control systems. These control systems may he used with any type of switch mode power supply but we will describe them with specific reference to a power supply in which a feedback is obtained from an auxiliary winding of the transformer. Background prior art relating to such power supplies can be found in WO 03/047079, US 2003/0132739, US 2003/0128018, US 2004/0037094, US 2004/0052095 and in US 2002/0001204. Further background prior art can be found in “One Solution Of Dc/Dc Converter With Adaptive Feedback Control” by Miroslav Lazic, Facta Universitatis, 1999 (http://factaee.elfak.ni.ac.yu/facta9903/facta7.pdf). A generalised version of such a power supply 10 is shown in FIG. 1. This comprises an AC mains input 12 coupled to a bridge rectifier 14 to provide a DC supply to the input side of the power supply. This DC supply is switched across a primary winding 16 of a transformer 18 by means of a switch 20, in this example an insulated gate bipolar transistor (IGBT). A secondary winding 22 of transformer 18 provides an AC output voltage which is rectified to provide a DC output 24, and an auxiliary winding 26 provides a feedback signal voltage proportionally to the voltage on secondary winding 22. This feedback signal provides an input to a control system 28, powered by the rectified mains, this control system providing a drive output 30 to switching device 20, modulating either pulse width or pulse frequency to regulate the transfer of power through transformer 18, and hence the voltage of DC output 24. Broadly speaking, when switch 20 is on the current in primary winding 16 ramps up storing energy in the magnetic field of transformer 18 and then when switch 20 is opened there is a steep rise in the primary voltage (and hence also in the secondary voltage) as the transformer attempts to maintain its magnetic field; the spikes in the secondary voltage are smoothed by a smoothing circuit, typically an output capacitor 32.

A general aim for the control system of a switch mode power supply is to achieve stable output voltage regulation coupled with a timely transient response across a wide variety of application architectures, operating modes, input conditions, and output load conditions.

According to a first aspect of the present invention there is therefore provided a digital control system for a switch mode power supply (SMPS), the control system having a demand input to receive a demand signal indicating whether an output voltage of said SMPS is above or below a desired value, and a drive output to provide a switching control signal to a switch controlling energy transfer between an input and an output of said SMPS during a power switching cycle of the SMPS, the control system further comprising: a signal processor coupled to said demand input and to said drive output to control said drive output responsible to said demand signal to regulate said output voltage at said desired value, and wherein said signal processor comprises at least one storage element to store at least one value of said demand signal, and wherein said switching control signal for a said power switching cycle is responsive to a values of said demand signal in at least two previous power switching cycles.

In embodiments by making the switching control signal responsive to a history of values of the demand signal in previous power switching cycles advanced control techniques become possible. Preferably the demand signal relates to the switch mode power supply output voltage during the single power switching cycle and the historical values of the demand signal may then comprise demand signal values for successive or sequential power switching cycles and the demand signal values in a current and 1, 2, or more previous power switching cycles may then be used to control the switching control signal for the next power switching cycle. Thus preferably the signal processor includes a plurality of storage elements and the switching control signal is responsive to demand signal values in 3 or more power switching cycles.

In a preferred embodiment the current and previous values of the demand signal provide a vector which is used as an address for a lookup table storing control signal adjustment values for adjusting the switching control signal. These adjustment values may comprise, for example, values indicating a change in the output power level (energy transferred) for the next power switching cycle. In embodiments the demand signal values for the two or more power switching cycles and the lookup table may be implemented using a finite impulse (FIR) filter.

Counter intuitively, in preferred embodiments the adjustment values are larger when the demand signal values (either the demand signal value itself or the history of demand signal values) indicate that the output voltages consistently to one or other side of the desire value then when, for example, the demand signal values indicate transitions of the output voltage from above to below the desired value or vice versa. Thus, in effect, preferably larger adjustments (corrections) are made when the output value is close to the desired value than when it is further away from the desired value. This facilitates a very fast response of the power supply output voltage to transient changes in load, typically of a similar order to the clock period. For example, for a power supply operating at a nominal clock frequency of 100 kHz, an analogue control system may take of the order of a millisecond to respond to a transient change in loading and show some ringing, whereas embodiments of a control system according to the present invention may respond in only 10 to 100 microseconds. However, as described in more detail later, although a running total of the desired power (energy transfer) level is kept, only the most significant part of this running total (the top one or more bits) is employed in actually modulating the switching control signal so that, in embodiments, a plurality of successive adjustments may be needed to a desired to a desired power level before the switching control signal is changed. In embodiments of the system there is no adjustment value of zero so that whatever the history of demand signal values some adjustment is always made (either directly to the control signals or indirectly to the control signal by adjusting a stored power level value), this aiming to ensure that the power level targeted by the control system is always oscillating at a relatively high frequency. This facilitates a rapid response to transient load changes. An example of a table of power level adjustment values is given later; in this example table the adjustment values are smallest when the output voltage has been consistently above (or below) a desired value for a plurality of cycles and largest when the output voltage has just crossed (in a current or previous) power switching cycle from one side to the other side of the desired value.

In preferred embodiments the above described control system implements one or more of the following additional features, described further below: Logarithmically spaced power levels; a combination of both pulse width and pulse period modulation of the switching control signal; and a selection of pulse width and/or periods (in terms of number of cycles of a higher frequency clock of the control system) such that at least some of the desired power levels, preferably adjacent power levels have pulse widths/periods which lack a common dividing factor, to spread RF and/or audio emissions.

According to another aspect of the present invention there is provided a method of controlling a switch mode power supply (SMPS), the method comprising: inputting a demand signal indicating whether an output voltage of said SMPS is above or below a desired value; filtering said demand signal using a finite impulse response filter to provide a filtered demand signal; and outputting a switching control signal responsive to said filtered demand signal for controlling a switch, said switch controlling energy transfer between an input and an output of said SMPS during a power switching cycle of the SMPS.

The invention further provides a control system for a switch mode power supply (SMPS), the control system having a feedback input for receiving a feedback signal dependent upon an output level of the SMPS said feedback signal indicating whether said output level is above or below a desired output level, the control system providing a control signal output for controlling said SMPS output level, wherein the control system is configured to adjust said control signal output responsive to an error signal derived from successive values of said feedback signal, said error signal being larger when said successive feedback signal values indicate that said output level is changing between levels above and below said desired level than when said successive feedback signal values indicate that said output level is consistently above or below said desired level.

In a related method the invention also provides a method of controlling a switch mode power supply (SMPS), the method comprising: inputting a feedback signal dependent upon an output level of the SMPS; and outputting a control signal for controlling said SMPS output level; the method further comprising: adjusting said control signal by an amount which is larger when successive feedback signal values indicate that said output level is changing between levels above and below said desired level then when said successive feedback signal values indicate that said output level is consistently above or below said desired level.

In another aspect the invention provides a control system for a switch mode power supply (SMPS), the control system having a feedback input for receiving a feedback signal dependent upon an output level of the SMPS and outputting a control signal for controlling said SMPS output level, and wherein the control system is configured to adjust said control signal to control said SMPS output in accordance with an adjustment signal derived from said feedback signal, said adjustment signal increasing as a difference between said output level and a desired output level decreases.

The control signal is adjusted to control the SMPS output or desired power level in accordance with, for example proportional to, the adjustment signal so that a large adjustment signal results in a large adjustment and a smaller adjustment signal a smaller adjustment. As previously mentioned, preferably the output voltage level is regulated on a per power switching cycle basis.

The invention also provides a method of controlling a switch mode power supply (SMPS), the method comprising: inputting a feedback signal dependent upon an output level of the SMPS; and outputting a control signal for controlling said SMPS output level; the method further comprising: adjusting said control signal by an amount which increases as said output level approaches a desired value.

In a further aspect the invention provides a control system for a switch mode power supply (SMPS), the control system having a demand input to receive a demand signal indicating whether an output voltage of said SMPS is above or below a desired value, and a drive output to provide a switching control signal to a switch controlling energy transfer between an input and an output of said SMPS during a power switching cycle of the SMPS, the control system further comprising: a signal processor coupled to said demand input and to said drive output to control said drive output responsive to said demand signal to regulate said output voltage at said desired value, wherein said switching control signal comprises a succession of pulses, and wherein said signal processor is configured to modulate both a pulse frequency and a pulse width of said succession of pulses responsive to said demand signal to regulate said output voltage.

In embodiments changing both the pulse width and pulse frequency (period) facilitates the provision of a greater dynamic range for the switching control system. For example with a maximum power switching cycle frequency of, say, 500 KHz, to achieve a 500:1 dynamic range by varying frequency alone would require a reduction in frequency down to 1 KHz (the audio range) whereas a much smaller reduction in frequency can be employed if a pulse width or duty cycle is also changed. Broadly speaking (the output) power level of the power supply or energy transferred per switching cycle, is proportional to the square of the pulse on time and inversely proportional to the pulse frequency.

In a preferred embodiment to enable the variation of both pulse frequency or period and pulse width a lookup table is provided indexed by a desired power level and defining, for each power level a pulse width and pulse period. These can then be used to control the switching control signal, for example by outputting a control signal to turn a switching device on and at substantially the same time starting a count, turning the switching control signal (and switching device) off when a pulse width count is reached and continuing to count until a pulse period count is reached before beginning the next power switching cycle. In embodiments pulse width and/or period are measured in terms of number of cycles of a control system clock.

In preferred embodiments the pulse period and pulse width combinations define a plurality of substantially logarithmically spaced output power levels for the switch mode power supply, for example increasing the output power level by approximately the same factor for each successive power level. This provides an optimum ripple response since the power level ripple is always proportionately approximately the same size at high and low power levels. Suitable pulse period and pulse width combinations may be selected by choosing a geometric progression factor, such as 2.5 to determine a succession of power level steps, then selecting pulse width (on time) and frequency in accordance with the above described relationship, choosing the closest integral number of control systems clock counts, preferably with pulse widths not less than a minimum number of clock cycle counts such as three clock cycles.

The number of available power levels defined by the lookup table may be varied, either as a design parameter, or as an operating parameter of the control system. For example, to provide a “bang bang” control in, for example, a burst mode intermediate power levels defined by the lookup table can, in effect, be removed leaving just the lowest and highest power levels. This enables a faster response to transient changes at the expense of increased ripple. Such a “bang bang” mode can be implemented, for example, when demand history values indicate that the output voltage has just over or under shot the target.

As previously mentioned, the different output power levels specified in the table may be defined such that one or both of pulse width and pulse period (in terms of numbers of clock cycles) lack a common factor. This spreads the RF spectral emissions and also reduces a risk of annoying audio emissions from a power supply, for example from an inductor or transformer. For this benefit it is not necessary that none of the output power levels share a common factor as some benefit can be obtained if only some of the output power levels (that is pulse widths and/or periods) lack a common factor.

Thus in another aspect the invention provides a control system for a switch mode power supply (SMPS), the control system having a feedback input for receiving a feedback signal dependent upon an output level of the SMPS and providing a control signal output for controlling an output power of said SMPS, and wherein said control system is configure to control said SMPS to operate at a selected one of a plurality of substantially logarithmically spaced power levels.

The invention further provides a control system for a switch mode power supply (SMPS), the control system having a demand input to receive a demand signal indicating whether an output voltage of said SMPS is above or below a desired value, and a drive output to provide a switching control signal to a switch controlling energy transfer between an input and an output of said SMPS during a power switching cycle of the SMPS, the control system further comprising: a signal processor coupled to said demand input and to said drive output to control said drive output responsible to said demand signal to regulate said output voltage at said desired value, and wherein said switching control signal comprises a plurality of pulses, said signal processor being configured to vary at least one of a width and a frequency of said pulses to regulate said output voltage, and wherein defined in terms of a number of cycles of said SMPS clock. Said signal processor is further configured to vary said at least one of pulse width and pulse frequency between discrete values such that at least some of said discrete values lack a common factor.

The invention further provides a method of controlling a switch mode power supply (SMPS), the method comprising: inputting a demand signal indicating whether an output voltage of said SMPS is above or below a desired value; and outputting a switching control signal for controlling a switch controlling energy transfer between an input and an output of said SMPS during a power switching cycle of the SMPS; wherein said switching control signal comprises a succession of pulses, the method further comprising: modulating both a pulse frequency and a pulse width of said succession of pulses responsive to said demand signal to regulate said output voltage.

The invention further provides a method of controlling a switch mode power supply (SMPS), the method comprising: inputting a feedback signal dependent upon an output level of the SMPS; and outputting a control signal for controlling an output power of said SMPS; the method further comprising: controlling said SMPS to operate at a selected one of a plurality of substantially logarithmically spaced power levels.

The invention further provides a method of controlling a switch mode power supply (SMPS), the method comprising: inputting a demand signal indicating whether an output voltage of said SMPS is above or below a desired value; and outputting a switching control signal for controlling a switch controlling energy transfer between an input and an output of said SMPS during a power switching cycle of the SMPS; wherein said switching control signal comprises a succession of pulses, the method further comprising: varying at least one of a width and a frequency of said pulses to regulate said output voltage, said varying comprising varying between discrete values such that at least some of said discrete values lack a common factor.

Aspects of the invention also provide a control system for a switch mode power supply configured to operate in accordance with the above described methods and including means for implementing these methods.

The above described control systems and signal processors may be implemented in dedicated hardware including, for example, an integrated circuit such as an ASIC (application specific integrated circuit) or FPGA (field programmable gate array) or in software, or in a combination of two.

Thus in a further aspect the invention provides processor control code, in particular on a carrier, for implementing the above described control systems and signal processors. The carrier may comprise any conventional data carrier such as a disk, CD- or DVD-ROM, programmed memory such as read only memory (firmware) or a data carrier such as an optical or electrical signal carrier. The processor control code may comprise a code and/or data in a conventional programming language such C, or microcode, or code for setting up or controlling an ASIC or FPGA, or RTL code, or code for a hardware description language such as Varilog (trademark), VHDL or SystemC. As the skilled person will appreciate such code and/or data may be distributed between a plurality of coupled components in communication with one or other.

Broadly speaking we will describe a digital switch mode power supply controller which is provided with an input signal which indicates on a power-cycle by power-cycle basis whether the SMPS output voltage is above or below a required value. This signal (data) is analysed by a finite impulse response (FIR) circuit which determines an adjustment value to be applied to an internally defined power level (defining a desired energy to be transferred per cycle between an input and the output of the power supply) ready for the following switching cycle in order to regulate the power supply's output voltage. The FIR implements a digital form of a proportional-integral derivative (PID) function, but preferably using a scheme which applies compensation inversely proportional to the errol. In preferred embodiments each discrete power level corresponds to a specific switching pattern on the controller output. Each power level is preferably spaced logarithmically from its neighbours, preferably by using a combination of pulse width modulation (PWM) and pulse frequence modulation (PFM). Preferably spectral emissions are spread by the use of non-factorial spacing of both pulse frequency and pulse width.

The various above described aspects of the invention may be combined in any permutation.

These and other aspects of the present invention will now be further described, by way of example only, with reference to the accompanying figures in which:

FIG. 1 shows a generalised example of a switch mode power supply;

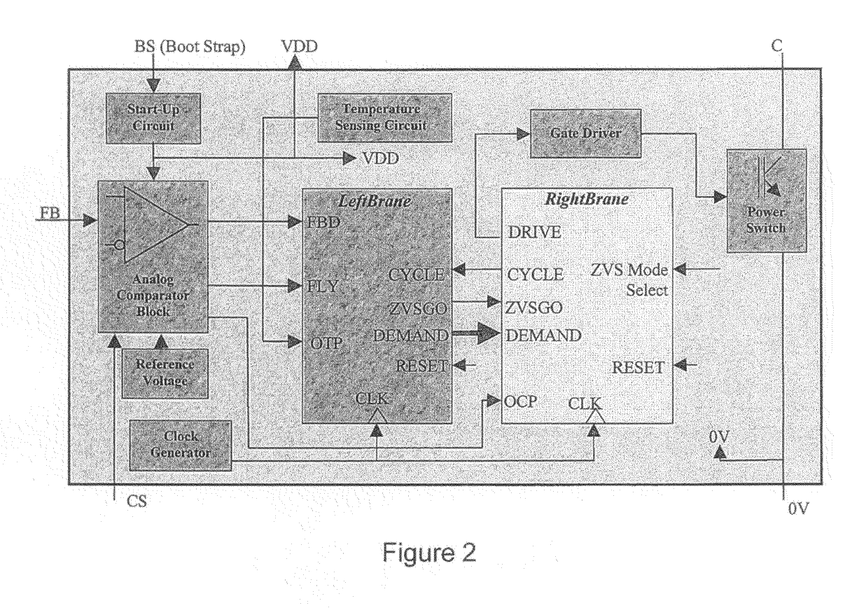

FIG. 2 shows an overview of a power integrated circuit (IC) embodying aspects of the present invention;

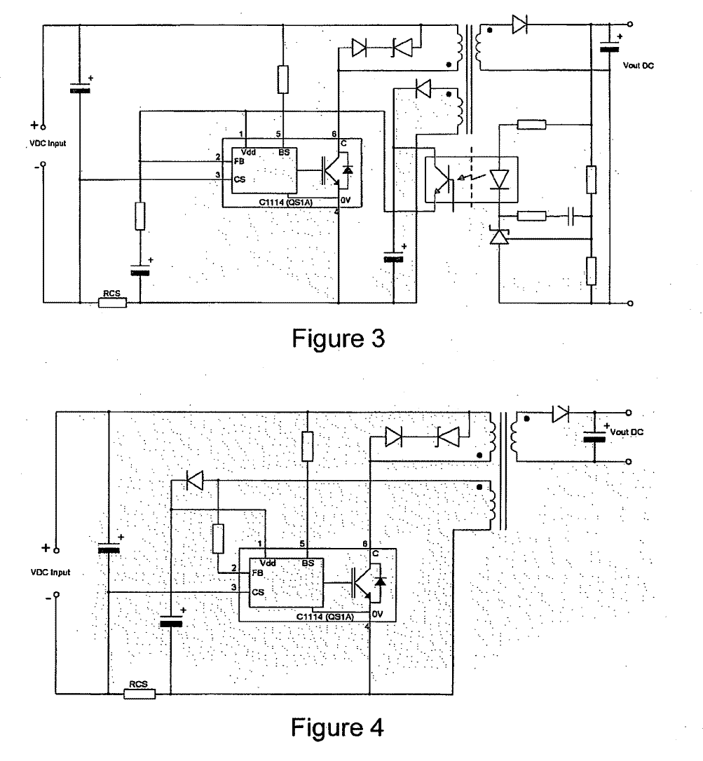

FIG. 3 shows a first example application of an embodiment of the invention, with static mode secondary regulation;

FIG. 4 shows a second example application of an embodiment of the invention, with dynamic mode primary side regulation;

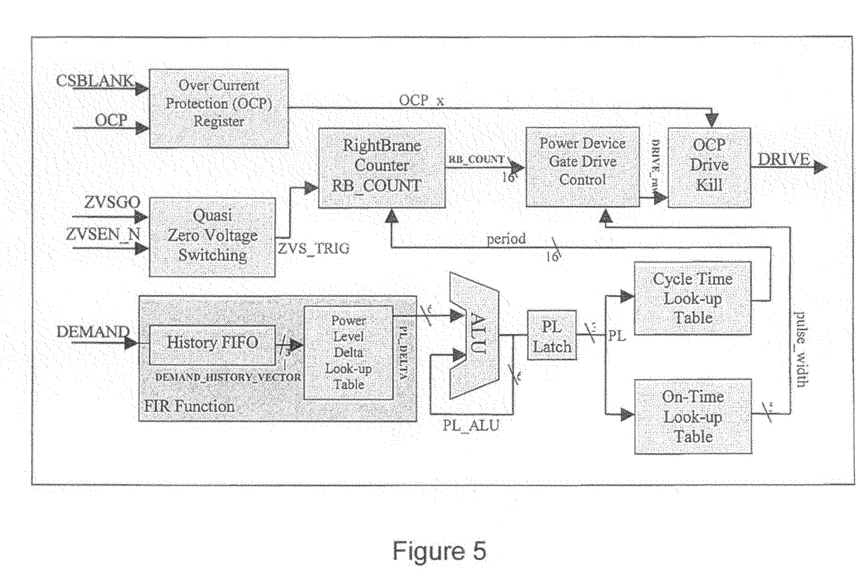

FIG. 5 shows an overview of a “RightBrane” system;

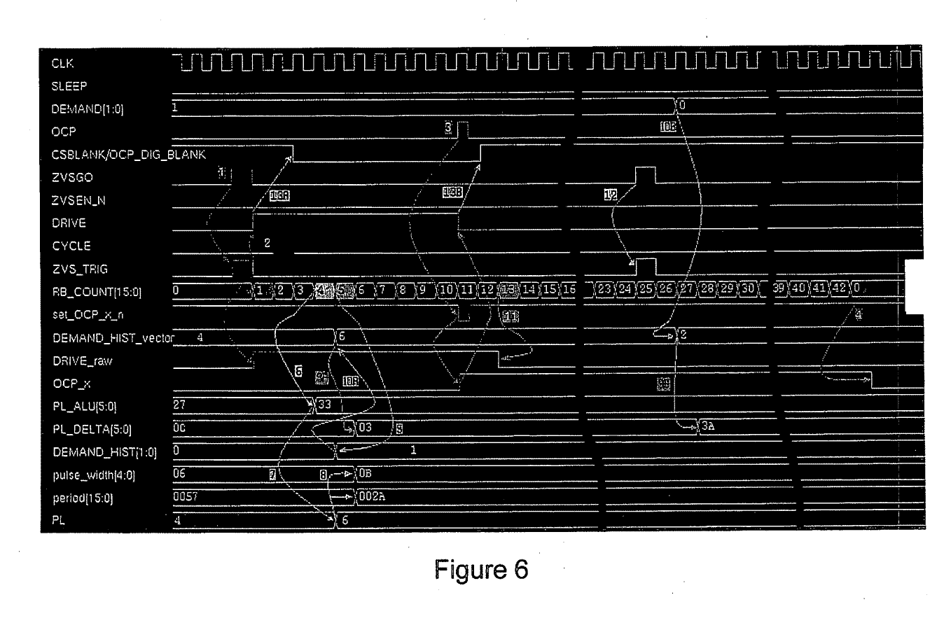

FIG. 6 shows “RightBrane” system timing;

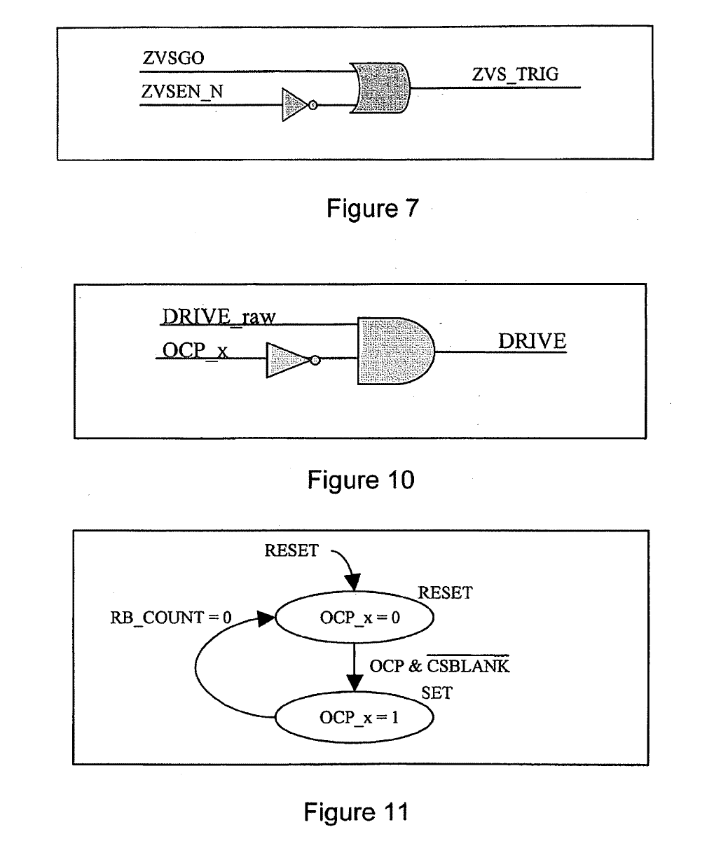

FIG. 7 shows a quasi zero-voltage switching enable circuit;

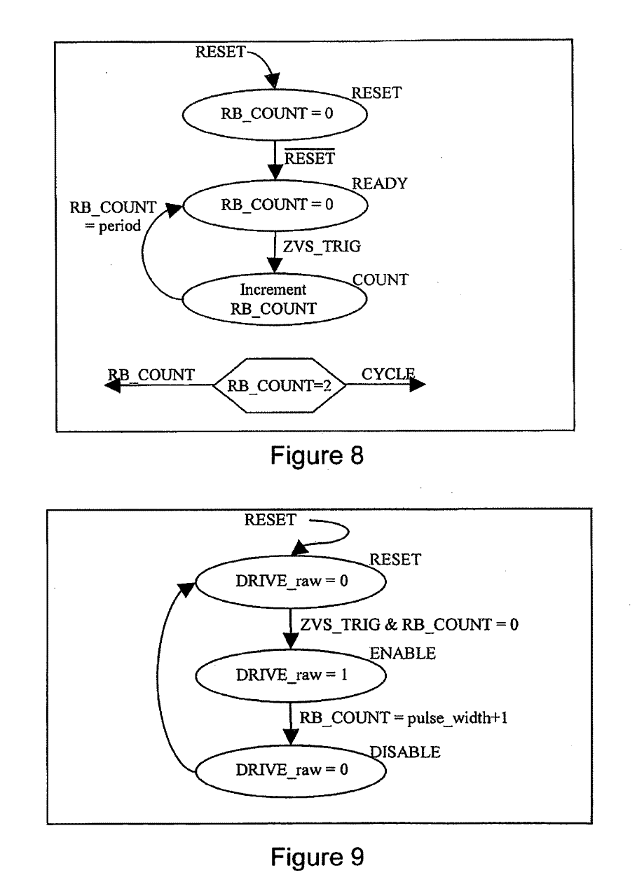

FIG. 8 shows switching cycle counter operation;

FIG. 9 shows DRIVE_raw pulse generator operation;

FIG. 10 shows a circuit for DRIVE disabling by an output of an over-current protection latch;

FIG. 11 shows asynchronous over-current protection latch operation;

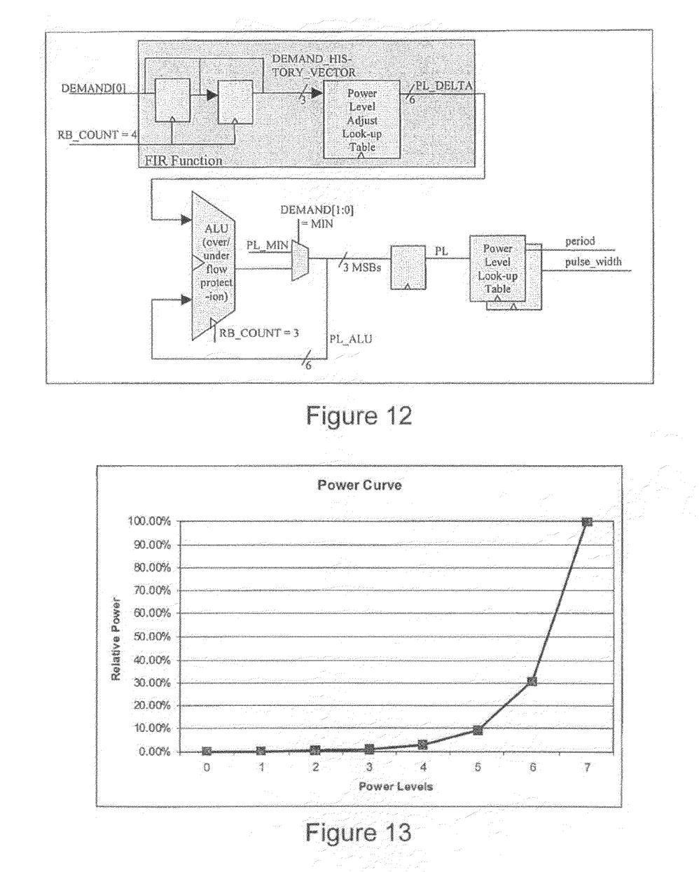

FIG. 12 shows a RightBrane power level calculation circuit;

FIG. 13 shows a graph of relative power against power level for an embodiment of the present invention;

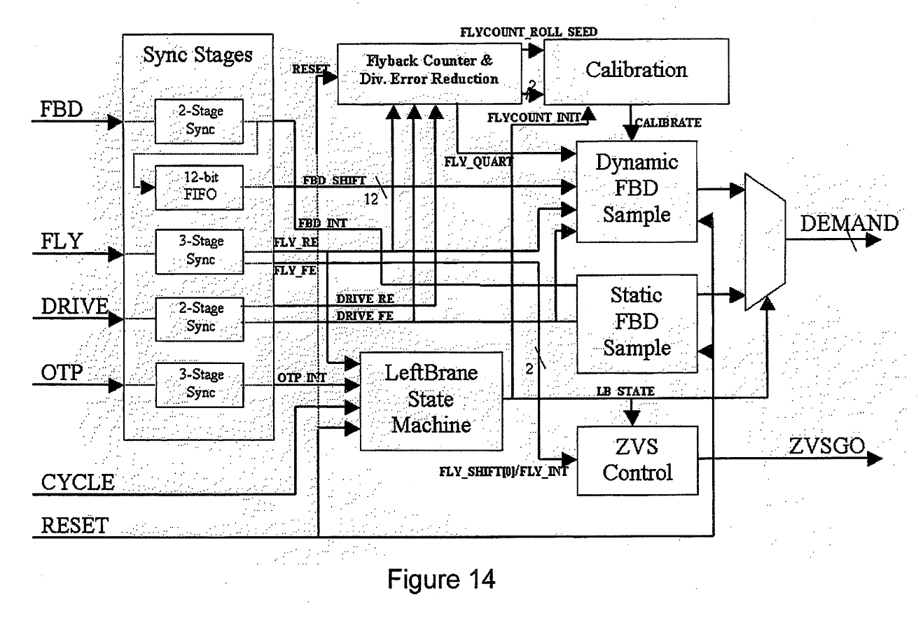

FIG. 14 shows an overview of a “LeftBrane” system;

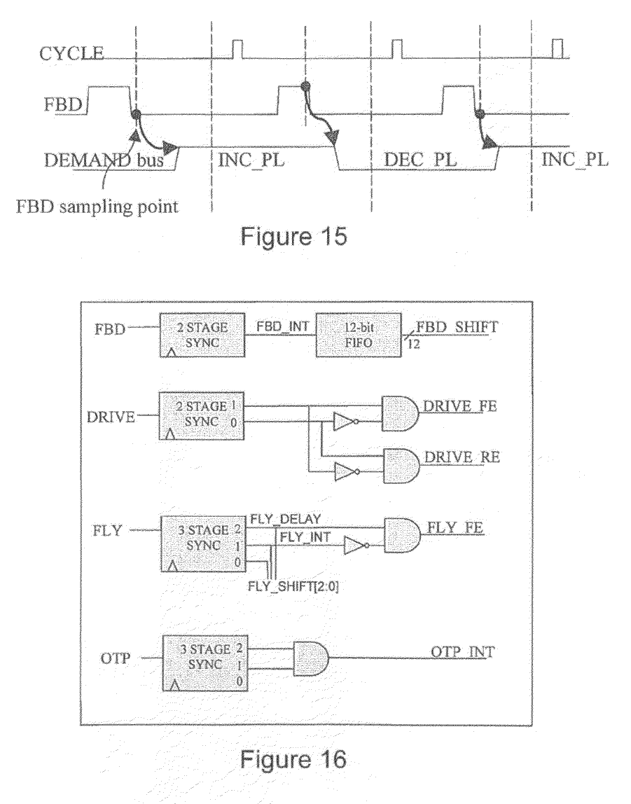

FIG. 15 shows FBD sampling-to-DEMAND bus timing;

FIG. 16 shows LeftBrane synchronising stages;

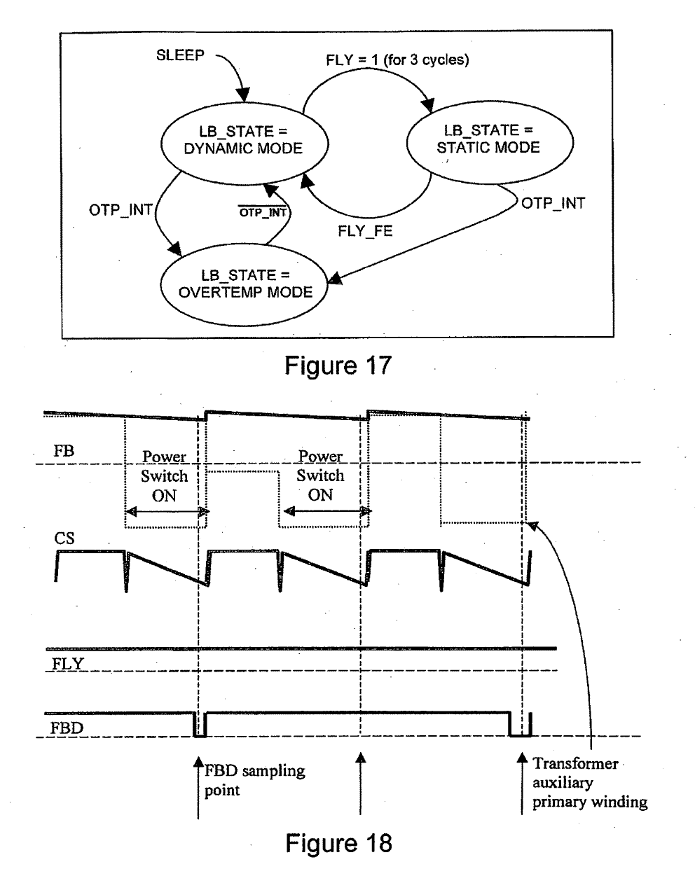

FIG. 17 shows a LeftBrane operating mode state machine;

FIG. 18 shows static mode operation with FBD sampling;

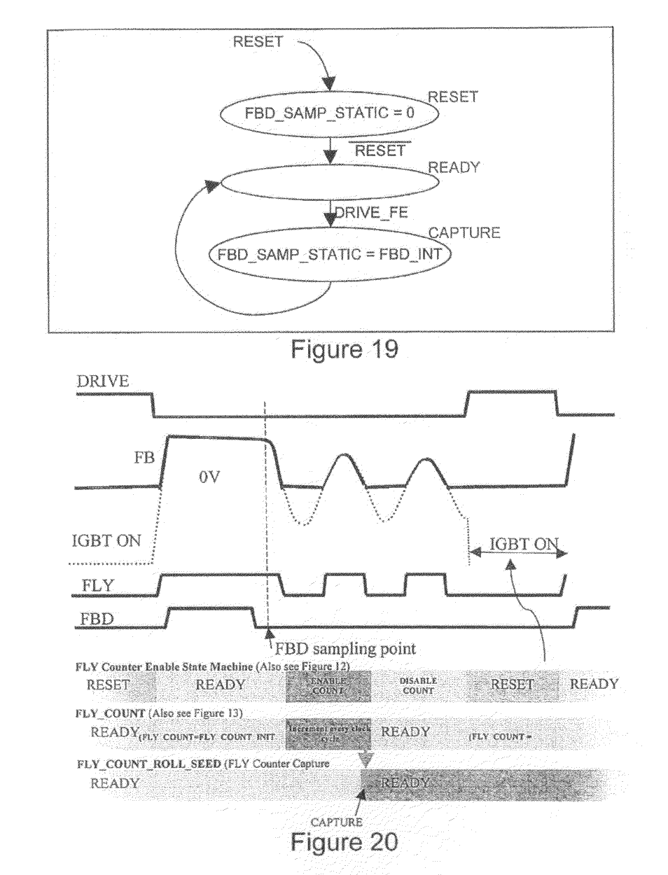

FIG. 19 shows a static feedback capture state machine;

FIG. 20 shows dynamic mode operation FBD sampling showing FLY_COUNT;

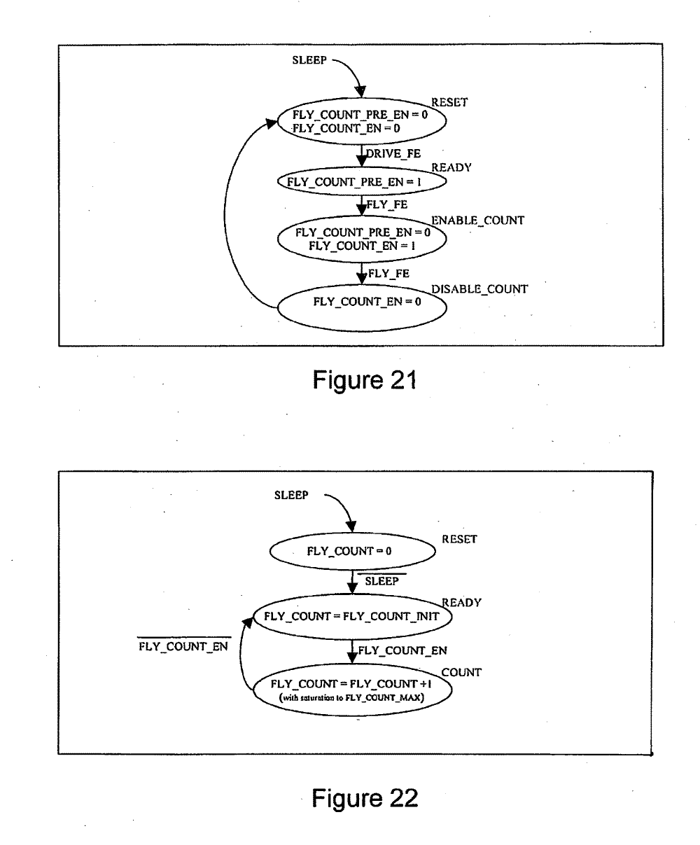

FIG. 21 shows a FLY counter enable state machine;

FIG. 22 shows a flyback oscillation period counter;

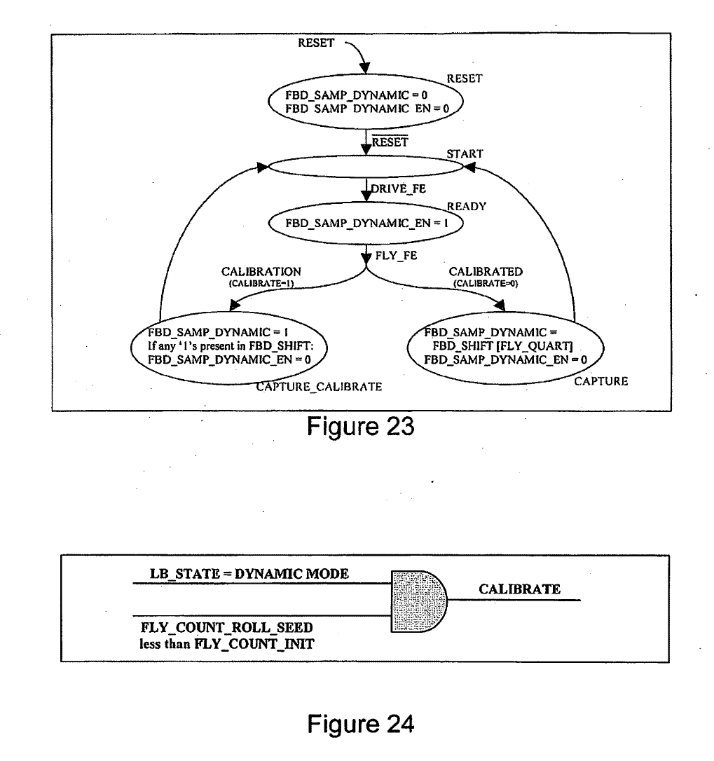

FIG. 23 shows a dynamic feedback capture state machine;

FIG. 24 shows a circuit for CALIBRATE signal generation;

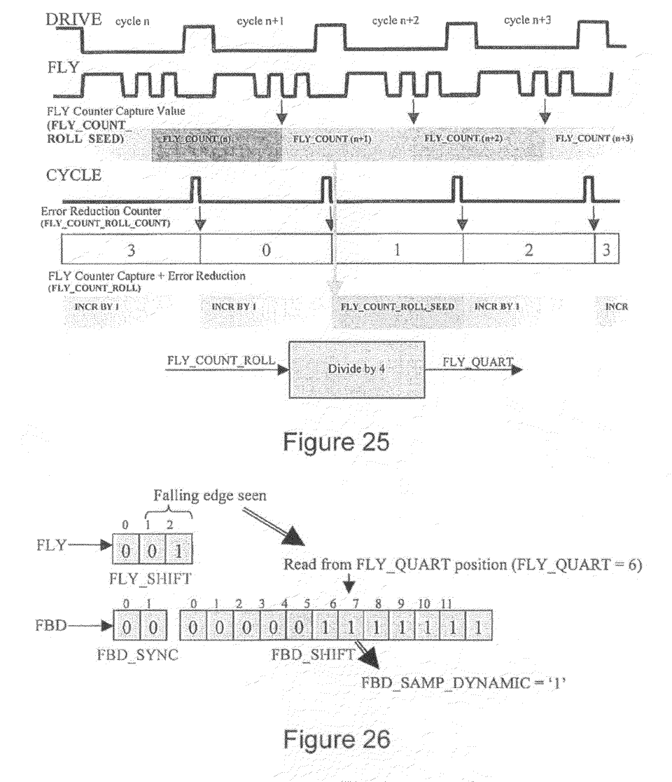

FIG. 25 shows FLY count capture and error reduction;

FIG. 26 shows Dynamic FBD capture registers;

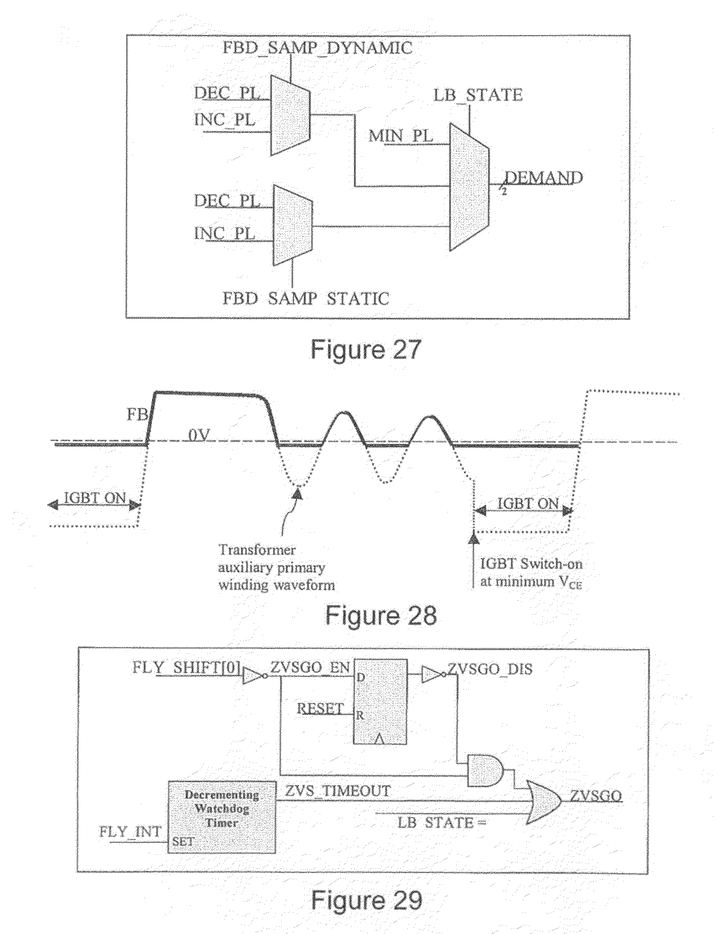

FIG. 27 shows an assigmnent to DEMAND circuit;

FIG. 28 shows an FB (feedback) waveform in dynamic mode for ZVS (zero-voltage switching) control; and

FIG. 29 shows QZVS (quasi zero-voltage switching) enable logic.

Aspects of the invention will now be described detail by describing a circuit referred to by the inventors as “RightBrane”, which is a preferred embodiment of the present invention.

The present invention forms a key part of a circuit used to control a switch mode power supply (SMPS) system. Typically, this invention will be implemented as part of a Power Integrated circuit as shown in FIG. 2, along with other components.

FIG. 2 shows RightBrane, an embodiment of the present invention located within a complete Power Integrated Circuit. RightBrane and another circuit we refer to as LeftBrane (also shown in FIG. 2) together form a complete digital SMPS controller.

FIGS. 3 and 4 show example applications of the SMPS integrated circuit of FIG. 2. FIG. 3 shows an example circuit configured to operate in what the inventors term a static mode of operation (which employs feedback from the secondary side of the SMPS for regulation); FIG. 4 shows an example circuit configured to operate in what the inventors term a dynamic mode of operation (which employs primary side regulation). In static mode the feedback from the secondary or output side of the power supply typically monitors the dc output voltage or some other secondary side voltage dependent thereon, whereas in dynamic mode the SMPS infers a voltage at the output side of the power supply by sensing the state of the energy transfer device, for example by using an auxiliary winding as shown.

In the example circuits of FIGS. 3 and 4 the current sense resistor R_{CS} is typically set at 330 mΩ but an alternative (greater) value may be calculated from the equation R_{CS}=V_{OCP}/OCP Ohms, where OCP is the required current limit. If the voltage developed across the resistor R_{CS} exceeds V_{OCP} the IGBT is switched off until the start of the next switching cycle and a blanking period (CSBLANK, described later) is preferably implemented to inhibit false triggering of the overcurrent protection at the start of each switching cycle. The remaining component values the example circuits of FIGS. 3 and 4 may be selected in accordance with conventional electronic design techniques as are well known to those skilled in the art.

In this specification LeftBrane is described in full after the description of RightBrane to help provide a complete description of a control system of which a preferred embodiment of the present invention is a constituent part.

The key function of RightBrane is to interpret feedback information collated by the LeftBrane based on the state of the switch mode power supply and generate a switching pattern for the power switch which will maintain die switch mode power supply output at the required level. Optionally a “BraneScan” module (not shown in FIG. 2 for clarity) may also be included to allow activation (overriding) of internal control signals to facilitate testing.

The RightBrane circuit will now be examined in more detail. The functional inputs and outputs of the RightBrane are shown in Table 1 below.

TABLE 1
RightBrane Functional Inputs and Outputs
Inputs

| | |
|---|---|
| DEMAND | Power Demand Indicator (from LeftBrane controller) |
| OCP | Over Current Protection error from analog comparator |
| | circuit |
| ZVSGO | qZVS Enable Trigger (from LeftBrane controller) |
| ZVS Mode Select | Zero Voltage Switching Mode Enable |
| CLK | System Clock input |
| RESET | Used as system reset |

Outputs

| | |
|---|---|
| CYCLE | Indicates start of new switching cycle to allow |
| | LeftBrane to synchronize with RightBrane |
| DRIVE | Output of RightBrane to Power Switch - used by |
| | LeftBrane to help determine correct FBD |
| | sampling point |

The key internal signals and sub-blocks within RightBrane are shown in Figure R2.

RightBrane receives a signal called DEMAND. The DEMAND signal (typically, for example, a binary signal) indicates whether more or less energy needs to be transferred to the SMPS output in order to maintain the correct output voltage. In preferred embodiments of a complete system the DEMAND signal is received from a LeftBrane system which forms another part of the overall control system, but in other arrangements any circuit which provides a suitable signal may be employed. The function of the LeftBrane (or other circuit) is to interpret the state of the SMPS output voltage and determine whether it is above or below a required value.

RightBrane processes the DEMAND signal and calculates which one of eight pre-defined power levels should be deployed to best maintain the SMPS output at the required voltage. The power level value, PL, directly determines the pulse width and switching period for the DRIVE signal. DRIVE provides the input to an optional buffering gate driver block which in turn drives the gate of a power MOSFET (or similar high voltage switching device) which facilitates the transfer of energy into the SMPS transformer. In the present embodiment, DEMAND is implemented as a 2-bit bus, with the least significant bit used to represent the DEMAND state as described above and the most significant bit used to indicate an error condition (Over Temperature) which when active forces the system to the minimum power level. Unless specifically stated, in the following detailed description the term DEMAND refers only to the least significant bit (but the skilled person will appreciate that a suitable DEMAND signal is not limited to a signal of this type and other embodiments of the invention may employ other types of DEMAND signal).

Other signals provided by the LeftBrane to the RightBrane are as follows: ZVSGO indicates that the SMPS Flyback oscillation is at a trough value—or local minimum voltage. For high efficiency operation, RightBrane has a Quasi Zero Voltage Switching Mode, selected by the active-low ZVSEN_N input, in which the start of a new switching cycle is held back until a Flyback oscillation trough value is reached. OCP, or Over Current Protection, indicates that the current within the power switching device has reached a permitted maximum value and that the DRIVE signal to the switching device should be turned off immediately. CSBLANK is used to mask the OCP function, for a short time after the switching device is turned on, when the current is allowed briefly to exceed its limits to accommodate a permitted short current spike which can occur due to the leakage inductance within the SMPS transformer.

The present embodiment has eight discrete power levels. The power level currently in use is determined by the 3-bit PL bus. The PL bus value is derived from the most significant 3-bits of the output of the 6-bit power level ALU, PL_ALU. Each power switching cycle, PL_ALU is adjusted by a 6-bit, power level adjust value, PL_DELTA. An FIR process is applied to the DEMAND signal, to determine the required value for PL_DELTA.

The decision to derive eight discrete power levels from a 6-bit ALU was made in order to give a cost-effective solution with a high level of precision and a good dynamic response. However, generally embodiments of this invention are fully applicable to other ALU sizes and numbers of power levels.

The present embodiment uses a 16-bit counter, RB_COUNT, which controls the timing of events within the RightBrane. It counts from zero up to the value of the period for the current power switching cycle. However, generally embodiments of this invention are equally applicable to other sizes of counter.

FIG. 6 shows the timing relationship of RB_COUNT and all the key signals within the RightBrane.

RB_COUNT begins incrementing from zero at the start of a new power cycle when it has completed its count for the previous power cycle AND it is enabled by the ZVS_TRIG signal. FIG. 6 shows Quasi Zero Voltage Switching operation, selected by ZVSEN_N being in its active low state, where RB_COUNT is held at zero until the RightBrane receives a ZVSGO signal from the LeftBrane. The chain of events triggered by the arrival of ZVSGO is numbered 1 in FIG. 6. Note that ZVSGO is ignored unless the present switching cycle has completed. Number 12 in FIG. 6, shows one such arrival of ZVSGO.

FIG. 7 shows the circuit used to generate the ZVS_TRIG signal. Note that when Quasi-Zero Voltage Switching is not required, ZVSEN_N is forced to its inactive state, which in turn forces ZVS_TRIG into its active high state, which enables the next power switching cycle to commence as soon as the present one has completed.

FIG. 8 shows the operation of the RB_COUNT Switching Cycle Counter. It also shows how the CYCLE output is pulsed while RB_COUNT equals 2. This output is fed to the LeftBrane, where it is used to keep it in synchronization with the RightBrane. The timing of these events are numbered 2 in FIG. 6.

The internal version of the DRIVE signal, DRIVE_raw, is set into its active state by the combination of RB_COUNT being 0 and ZVS_TRIG being active. This internal signal stays high until the counter reaches the pulse width value, determined by the present power level. As DRIVE_raw goes active, RB_COUNT increments to 1 on the same clock edge. This is part of the sequence of events labelled 1 in FIG. 6. The setting and resetting of DRIVE_raw is shown in FIG. 9. The fall of DRIVE_raw is numbered 11 in FIG. 6.

The output version of the DRIVE signal differs from DRIVE_raw in that it is asynchronously forced inactive if an over current protection (OCP) condition is detected. When the asynchronously latched fersion of OCP called OCP_x is active, the DRIVE output is reset to its inactive state. FIG. 10 shows the gating of DRIVE_raw with the output of the Over Current Protection Latch, OCP_x, to create the output form of DRIVE.

Any OCP event seen is captured, if it is not being blanked by CSBLANK, and latched in the form of OCP_x. The events triggered by OCP are numbered 3 in FIG. 6. OCP_x remains active until the start of the next power switch cycle (RB_COUNT equals 0), numbered 4 in FIG. 6. This prevents any small glitches or re-firing of the DRIVE output caused by OCP clearing at its source before the end of the DRIVE pulse width. FIG. 11 shows the operation of the OCP_x latch.

The RightBrane takes the DEMAND input from the LeftBrane and uses it to determine the optimum on-time and frequency of the DRIVE signal for each power switching cycle. The data path for this is shown in FIG. 12.

DEMAND[0] is fed into a shift register, which is updated at the time RB_COUNT increments to 5, see the events numbered 5 in FIG. 6. The shift register is 2-bits deep in the present embodiment, but the invention is not restricted to that specific width. The bits in the shift register are combined with the current DEMAND[0] bit to form a DEMAND_HISTORY_VECTOR, which is 3-bits wide in this example. The DEMAND_HISTORY_VECTOR is used as the input to a look-up table which gives the power level adjustment value to be applied to the current power level ALU value to best maintain the SMPS regulation. The adjustments or deltas, PL_DELTA, are shown in Table 2. Note that the PL_ALU value is always adjusted up or down, unless it is at its maximum or minimum values. An overflow and underflow protection circuit prevents the PL_ALU from incrementing beyond its maximum value or from decrementing below zero, either of which would give erroneous results. The effective output power level PL value will only change when there is change which affects the 3-MSB's of PL_ALU.

TABLE 2
FIR Look-up Table for PL_Delta

| DEMAND History | PL_DELTA |
|---|---|
| 000 | −1 |
| 001 | −3 |
| 010 | −6 |
| 011 | −12 |
| 100 | 12 |
| 101 | 6 |
| 110 | 3 |
| 111 | 1 |

DEMAND_HISTORY_VECTOR updates whenever either DEMAND changes (see the events numbered 10A in FIG. 6) or DEMAND_HISTORY updates (see the events numbered 10B in FIG. 6). It is the latter value which is used for the power level calculation in the following power switching cycle. Similarly, the PL_DELTA value updates one clock cycle after DEMAND_HISTORY_VECTOR (see the events numbered 9A and 9B in FIG. 6). Consequently it is the latter update which is added to the PL_ALU value in the following power switching cycle.

The new power level is calculated as the RightBrane counter, RB_COUNT, increments to 4 (see the events numbered 6 in FIG. 6), before the next DEMAND value is captured. If the current DEMAND is MIN_PL due to an OTP condition, then the power level immediately drops to the minimum power level of 0. Otherwise the power level adjustment, PL_DELTA, is added to the current power level ALU value (PL_ALU). There is a one clock cycle delay between PL_ALU and PL. This is shown in 7 in FIG. 6.

The resulting 3-bit power level, PL, is then used in the lookup table for the period and pulse_width values for the DRIVE signal. The lookup tables' contents are shown in Table 3, with an alternative implementation with a greater range of power shown in Table 4 (see below). The new values for the pulse width and switching cycle period are updated the clock cycle after PL is updated. See number 8 in FIG. 6.

The on-time and cycle-time for each power level are defined in terms of digital clock periods, with values chosen to give power levels that are spaced logarithmically. Tables 3 and 4 additionally give an indication of the relative power delivered. The data in Table 4 is also represented in graphical form as a ‘power curve’ in FIG. 13.

TABLE 3
Power Level Table

| Power Level | CYCLE count | ON count | Relative Power |
|---|---|---|---|
| 0 | 1024 | 4 | 0.20% |
| 1 | 420 | 4 | 0.48% |
| 2 | 172 | 4 | 1.16% |
| 3 | 110 | 5 | 2.83% |
| 4 | 88 | 7 | 6.90% |
| 5 | 60 | 9 | 16.82% |
| 6 | 43 | 12 | 41.02% |
| 7 | 32 | 16 | 100.00% |

TABLE 4
Power Level Table - An alternative embodiment

| Power Level | CYCLE count | ON count | Relative Power |
|---|---|---|---|
| 0 | 8191 | 4 | 0.02% |
| 1 | 2496 | 4 | 0.08% |
| 2 | 761 | 4 | 0.26% |
| 3 | 232 | 4 | 0.86% |
| 4 | 110 | 5 | 2.83% |
| 5 | 66 | 7 | 9.29% |
| 6 | 50 | 11 | 30.48% |
| 7 | 32 | 16 | 100.00% |

The RightBrane can be summarized as a circuit which analyses data provided on its DEMAND bus input and selects the appropriate power switch on times and power switch frequency values to correctly regulate the output of the switch mode power supply it is helping to control.

For completeness, the LeftBrane circuit (see again FIG. 2) will now be described in detail. The functional inputs and outputs of the LeftBrane are shown in Table 5.

The overall purpose of the LeftBrane is to collate and analyze feedback data from the switch mode power supply supplied to it via a number of analog comparators. The result of this analysis is passed onto the RightBrane in the form of a DEMAND signal which indicates whether more or less power should be supplied to the switch mode power supply.

TABLE 5
LeftBrane Functional Inputs and Outputs
Inputs

| | |
|---|---|
| FBD | Feedback Digital input - threshold crossing |
| FLY | Feedback Digital input - zero crossing |
| OTP | Over Temperature Protection from Temperature Sensing |
| | Circuit |
| CYCLE | Indicates start of new switching cycle to allow |
| | synchronization with RightBrane |
| DRIVE | Output of RightBrane to Power Switch - used by LeftBrane |
| | to help determine correct FBD sampling point |
| CLK | System Clock input |
| RESET | Used as system reset |

Outputs

| | |
|---|---|
| DEMAND | Demand output (to RightBrane controller) |
| ZVSGO | qZVS Enable timing output (to RightBrane) |

The prime function of the LeftBrane is to produce a DEMAND signal which indicates to the RightBrane whether the output voltage is above or below its target. This informs the RightBrane as to whether less or more power needs to be transferred to maintain the correct output voltage. This data is then processed by the RightBrane to determine the appropriate power level.

FIG. 14 shows a schematic overview of the LeftBrane.

Data derived from the feedback input FB, is provided to the LeftBrane in the form of two signals, FLY and FBD, which indicate the 0V and 5.0V crossings of FB, respectively.

The FBD signal is sampled by the LeftBrane in order to determine whether the power level needs to be increased or decreased. The FLY signal is used to determine when the FBD should be sampled depending on the feedback mode as described below.

All inputs need to be synchronized to the local clock to prevent meta-stability. The FLY and FBD signals are then shifted into FIFOs so that their history is stored.

In either STATIC or DYNAMIC modes, the FBD sampled value controls whether the DEMAND signal should indicate an increase or decrease in power level. If the sampled FBD is high then the DEMAND indicates a decrease, if the sampled FBD is low then the DEMAND indicates an increase. The DEMAND signal changes in time for the next power switching cycle as shown in FIG. 15.

In the present embodiment, DEMAND is implemented as a 2-bit bus, with the least significant bit used to represent the DEMAND state as described above and the most significant bit used to indicate an error condition (Over Temperature) which when active forces the system to the minimum power level. Unless specifically stated, the term DEMAND within this description refers only to the least significant bit. Table 6 shows the meaning of each DEMAND value.

TABLE 6
DEMAND Bus Values

| DEMAND bus | Function | Description |
|---|---|---|
| 00 | DEC_PL | Decrease power level |
| 01 | INC_PL | Increase power level |
| 10 | MIN_PL | Reduce to minimum power level |
| | | (Over Temperature Error) |
| 11 | MAX_PL | Not used |

The LeftBrane Synchronization logic is shown in FIG. 16.

The FBD, FLY and OTP inputs into the LeftBrane come directly from analog (and hence asynchronous) comparators, so need to be synchronised to the digital clock domain. The DRIVE input can be asynchronously cleared in the RightBrane, so also needs to be synchronised into the LeftBrane. The CYCLE input can be used without synchronization, as the LeftBrane and RightBrane operate within the same digital clock domain. The synchronization logic is also used to determine the rising and falling edges of some of these inputs for use in the control algorithm.

After synchronization, The FBD input is shifted into a FIFO (12-bits long in the present embodiment), which forms part of the DYNAMIC mode sampling routine.

FIG. 17 shows how the LeftBrane determines which operating mode it is in. If a falling edge is seen on FLY (indicated by FLY_FE), then the LeftBrane goes into DYNAMIC mode. If FLY remains high for three CYCLE pulses then the LeftBrane goes into STATIC mode. If the synchronized OTP input (OTP_INT) indicates an over temperature state then the LeftBrane goes into Over Temperature Error mode. These modes determine the sampling behaviour of the LeftBrane.

In STATIC Mode, the FBD input is sampled just before the end of the power switch conduction period, as shown in FIG. 18. As a result the FBD signal is active high if V_{FB}+R_{CS}·I_{IGBT} is greater than a threshold, for example 5 volts. The I_{IGBT} term provides cycle-by-cycle current feedback assisting control loop stability; in alternative embodiments a fraction of I_{IGBT} such as I_{IGBT}/10 may be employed.

In practice, this is achieved by sampling FBD_INT when the falling edge of DRIVE is detected and flagged by the DRIVE_FE signal. The paths taken by DRIVE and FBD to generate DRIVE_FE and FBD_INT have matched synchronization delays, so give a good representation of the actual FBD value at the time that DRIVE went low. The delay through the gate driver block helps ensure that the captured value of FBD represents the FB value at the end of the POWER SWITCH conduction period, rather than at the start of the SMPS flyback period. The operation of the state machine managing the sampling of FBD in Static mode is shown in FIG. 19.

When the LeftBrane is in DYNAMIC mode, the FBD sampling point is specified to be ¼ of the flyback oscillation period before the first falling edge of FLY. Typical waveforms for DYNAMIC Mode operation are shown in FIG. 20.

Central to Dynamic mode operation is the ability to measure the resonant frequency of the SMPS flyback. From this measurement a value FLY_QUART, ¼ of the flyback oscillation period can be calculated. In every switching cycle where a full flyback oscillation occurs, the period of that oscillation is measured, between the first and second falling edges of the FLY signal. In practice, a count is initiated on the first falling edge of FLY using a counter FLY_COUNT (6-bits in the present embodiment). If a full oscillation occurs, the final value of FLY_COUNT is loaded into a register FLY_COUNT_ROLL_SEED (again 6-bits in the present embodiment). Note that at higher power levels, a full oscillation may not occur due to DRIVE being asserted, so FLY_COUNT_ROLL_SEED is not updated and the previous value retained. FLY_QUART is essentially FLY_COUNT_ROLL_SEED divided by 4, with an error compensation technique to take any remainder from the division into account. The error compensation mechanism is discussed in more detail later.

The flyback counter increments the FLY_COUNT value every clock cycle, while the flyback counter enable state machine is in the ENABLE COUNT state. On the falling edge of the next FLY, the state machine disables the counter and the count value is transferred into the capture register, FLY_COUNT_ROLL_SEED. If a complete flyback oscillation does not occur, the FLY_COUNT value is discarded. Once the FLY_COUNT value has been transferred or discarded, indicated by the FLY_COUNT_EN signal going inactive, it is reset ready for the next power switching cycle. In the present embodiment, the counter is reset to a non-zero constant FLY_COUNT_INIT, which is set to an appropriate starting value to obtain the optimal measurement of the flyback oscillation period. The flyback counter should be designed to have the capacity to measure the maximum flyback oscillation period, which the overall switch mode power supply can reasonably be expected to encounter. Nonetheless, the flyback counter is equipped with a protection mechanism, which holds the counter at its maximum value, should it be reached, rather than let it roll back over to zero.

The captured value, FLY_COUNT_ROLL_SEED. should not significantly change from cycle to cycle, as it is determined by the characteristics of the transformer and other parts of the SMPS system. A±1 clock cycle variation may occur due to clock granularity.

State flow diagrams for the Flyback Counter Enable State Machine and Flyback Counter itself are shown in FIGS. 21 and 22 respectively.

The operation of the Dynamic Mode Feedback Capture State Machine is shown in FIG. 23. There are two-sub-modes of operation: Calibration and Calibrated. The Calibration sub-mode is deployed until a successful measurement of the flyback oscillation period has been achieved.

A successful measurement will cause the FLY_COUNT_ROLL_SEED value to be greater than the FLY_COUNT_INIT value and indicates that the LeftBrane is no longer calibrating. FIG. 24 shows the circuit used to generate the CALIBRATE signal.

FIG. 23 shows the two sub-modes of operation of the Dynamic Feedback Capture State Machine. In the Calibration sub-mode, the presence of any ‘1’ in the whole of the FBD_SHIFT register at the time of the first falling edge of FLY causes the FBD_SAMP_DYNAMIC signal to be set to ‘1’. This simply indicates that FB has reached its threshold value (5.0V in the present embodiment) during the course of the present switching cycle and allows a simple form of regulation to operate until we have exited the Calibration sub-mode.

Once Calibration has occurred, the circuit must ensure that the value of FBD is correctly captured at a sampling point ¼ of the flyback oscillation period before the first falling edge of FLY. Until the falling edge of FLY, the circuit does not know where this sampling point occurs. To compensate for this, a historical record of FBD is created in the FBD_SHIFT register, which is 12-bits long in the present embodiment. Once FLY_FE indicates that the FLY signal has fallen, the circuit can index back into the FBD_SHIFT register to determine the value of FBD at a time ¼ of a flyback oscillation period prior to the FLY falling edge.

FIG. 25 shows a pattern of DRIVE pulses and the resultant pattern on the FLY signal in Dynamic mode. FLY_COUNT (not shown) begins incrementing on the first falling edge of FLY and continues until the second falling edge of FLY or until a new switching cycle commences. If a complete flyback period is captured, FLY_COUNT_ROLL_SEED is loaded with the FLY_COUNT value. FLY_COUNT_ROLL_SEED is loaded into the divide error reduction counter once every four power switching cycles. It is effectively incremented by 1 each cycle and divided by 4 to give a divide-error-compensated FLY_QUART value.

The effect of the divide error reduction counter is best described with a numerical example, using decimal number values.

Without the divide error reduction counter a flyback oscillation period of for example 23 would result in a FLY_QUART value of 5, that is 23/4 less the remainder. Thus there would be an average error of 0.75 on FLY_QUART. However with the error reduction counter in place, the same starting value of 23 would produce FLY_QUART values of (23+0)/4=5, (23+1)/4=6, (23+2)/4=6, (23+3)/4=6 giving a mean value of 5.75.

The FLY_QUART value is used to index into the FBD shift register, as shown in FIG. 26, as the first FLY falling edge is seen. This is equivalent to reading the FBD value at the sampling point shown in FIG. 20.

As previously stated, a 2-bit DEMAND signal is passed to the RightBrane, determined by the sampled FBD value and the operating state of the LeftBrane module given by the LB_STATE bus. An overview of the circuit which implements this function is shown in FIG. 27.

For Critical Mode Conduction (CRM), the power switch should be turned on again at the trough of the first flyback oscillation. Switching on during subsequent troughs gives psuedo or quasi Zero Voltage Switching (qZVS), which is desirable to achieve high efficiency by minimizing the losses associated with the power switch turn-off transition. This behaviour is shown in FIG. 28. The power switch is turned back on again at a valley point on the FB waveform, which the LeftBrane determines by examining the FLY signal. CRM and qZVS is only available in Dynamic mode as it is reliant on examining transitions on the FLY waveform.

The LeftBrane determines the optimum firing window for DRIVE when in DYNAMIC mode, and passes this information to the RightBrane. The RightBrane will use this information if ZVS Mode is selected, otherwise, it will be ignored. The circuit used to achieve this is shown in FIG. 29. The circuit provides an output signal ZVSGO, which permits the RightBrane to commence a new power switching cycle. Note that in STATIC Mode, ZVSGO is forced permanently high.

In the present embodiment ZVSGO is triggered as soon as the falling edge of FLY is detected within the LeftBrane. Given that there will be a delay due to the gate driver and the ‘inertia’ of the power switch, which typically approximates to ¼ of the flyback oscillation period then this mechanism ensures the power switch turn on occurs close to the bottom of the flyback oscillation troughs. An extension of the present embodiment would be to use the existing FLY_QUART value as a delay following the point at which the FLY signal goes low. This with suitable delay compensation would give a very accurate indication of the bottom of the flyback trough.

The LeftBrane can be summarized as a circuit which interprets data provided on its FBD and FLY inputs to build up a detailed picture of the configuration and state of the switch mode power supply it is helping control and then passes appropriate power demand data on its DEMAND bus output to another part of the control circuit.

No doubt many other effective alternatives will occur to the skilled person. It will be understood that the invention is not limited to the described embodiments and encompasses modifications apparent to those skilled in the art lying within the spirit and scope of the claims appended hereto.

1. A digital control system for a switch mode power supply (SMPS), the control system having a demand input to receive a demand signal indicating whether an output voltage of said SMPS is above or below a desired value, and a drive output to provide a switching control signal to a switch controlling energy transfer between an input and an output of said SMPS during a power switching cycle of the SMPS, the control system further comprising:
a signal processor coupled to said demand input and to said drive output to control said drive output responsive to said demand signal to regulate said output voltage at said desired value, and wherein
said signal processor comprises at least one storage element to store at least one value of said demand signal, and wherein said switching control signal for a said power switching cycle is responsive to values of said demand signal in at least two previous power switching cycles.

2. A digital control system as claimed in claim 1 wherein said demand signal relates to said SMPS output voltage during a single said power switching cycle.

3. A control system as claimed in claim 1 wherein said signal processor includes a plurality of said storage elements, and wherein said switching control signal for a said power switching cycle is responsive to values of said demand signal in three or more previous power switching cycles.

4. A digital control system as claimed in claim 1, wherein said signal processor further comprising a control signal adjustment lookup table storing a plurality of adjustment values to provide, responsive to said values of said demand signal, a selected one of said adjustment values for adjusting said control signal.

5. A digital control system as claimed in claim 4 wherein said stored adjustment values are configured to make a larger adjustment to said control signal when said demand signal values indicate that said output voltage is consistently to one side of said desired value than when said demand signal values indicate one or more transitions of said output from one side to another side of said desired value.

6. A digital control system as claimed in claim 1 wherein said signal processor comprises a finite impulse response filter.

7. A digital control system as claimed in claim 1 wherein said signal processor comprises digital signal processing circuitry.

8. A carrier carrying processor control code for implementing the signal processor of claim 1.

9. A switch mode power supply incorporating the control system of claim 1.

10. A method of controlling a switch mode power supply (SMPS), the method comprising:
inputting a demand signal indicating whether an output voltage of said SMPS is above or below a desired value;
filtering said demand signal using a finite impulse response filter to provide a filtered demand signal; and
outputting a switching control signal responsive to said filtered demand signal for controlling a switch, said switch controlling energy transfer between an input and an output of said SMPS during a power switching cycle of the SMPS.

11. A method as claimed in claim 10 wherein said filtered demand signal comprises an error signal which increases as a difference between said output voltage and said desired value decreases.

12. A method as claimed in claim 10 wherein said inputting, outputting, and controlling is performed digitally each said power switching cycle.

13. A control system for a switch mode power supply (SMPS), the control system having a feedback input for receiving a feedback signal dependent upon an output level of the SMPS said feedback signal indicating whether said output level is above or below a desired output level, the control system providing a control signal output for controlling said SMPS output level, wherein the control system is configured to adjust said control signal output responsive to an error signal derived from successive values of said feedback signal, said error signal being larger when said successive feedback signal values indicate that said output level is changing between levels above and below said desired level than when said successive feedback signal values indicate that said output level is consistently above or below said desired level.

14. A method of controlling a switch mode power supply (SMPS), the method comprising:
inputting a feedback signal dependent upon an output level of the SMPS; and
outputting a control signal for controlling said SMPS output level;
the method further comprising:
adjusting said control signal by an amount which is larger when successive feedback signal values indicate that said output level is changing between levels above and below said desired level then when said successive feedback signal values indicate that said output level is consistently above or below said desired level.

15. A control system for a switch mode power supply (SMPS), the control system having a feedback input for receiving a feedback signal dependent upon an output level of the SMPS and outputting a control signal for controlling said SMPS output level, and wherein the control system is configured to adjust said control signal to control said SMPS output in accordance with an adjustment signal derived from said feedback signal, said adjustment signal increasing as a difference between said output level and a desired output level decreases.

16. A control system as claimed in claim 15 further comprising a lookup table to generate said adjustment signal.

17. A switch mode power supply incorporating the control system of claim 15.

18. A method of controlling a switch mode power supply (SMPS), the method comprising:
inputting a feedback signal dependent upon an output level of the SMPS; and
outputting a control signal for controlling said SMPS output level;
the method further comprising:
adjusting said control signal by an amount which increases as said output level approaches a desired value.

19. A switch mode power supply controller configured to operate in accordance with the method of claim 18.

20. A switch mode power supply incorporating the control system of claim 13.

21. A control system for a switch mode power supply (SMPS), the control system having a demand input to receive a demand signal indicating whether an output voltage of said SMPS is above or below a desired value, and a drive output to provide a switching control signal to a switch controlling energy transfer between an input and an output of said SMPS during a power switching cycle of the SMPS, the control system further comprising:
a signal processor coupled to said demand input and to said drive output to control said drive output responsive to said demand signal to regulate said output voltage at said desired value, wherein said switching control signal comprises a succession of pulses, and wherein
said signal processor is configured to modulate both a pulse frequency and a pulse width of said succession of pulses responsive to said demand signal to regulate said output voltage.

22. A control system as claimed in claim 21 wherein said signal processor further comprises a pulse lookup table defining a plurality of pulse period and pulse width combinations, each said combination corresponding to an output power level of said SMPS, and wherein said signal processor is configured to select a said pulse period and pulse width combination from said table for said switching control signal responsive to said demand signal.

23. A control system as claimed in claim 22 wherein said pulse period and pulse width combinations define a plurality of substantially logarithmically spaced output power levels of said SMPS.

24. A control system as claimed in claim 22 wherein a pulse period and a pulse width of a said combination are defined in terms of a number of cycles of an SMPS clock, and wherein said combinations are selected such that for combinations defining different SMPS output power levels at least one of said pulse period and pulse width in terms of number clock cycles lack a common factor.

25. A control system for a switch mode power supply (SMPS), the control system having a feedback input for receiving a feedback signal dependent upon an output level of the SMPS and providing a control signal output for controlling an output power of said SMPS, and wherein said control system is configured to control said SMPS to operate at a selected one of a plurality of substantially logarithmically spaced power levels.

26. A control system as claimed in claim 25 wherein said SMPS has power switching cycles for transferring energy from an input to an output of the SMPS, and wherein said control system is configured to select a said power level for each power switching cycle of said SMPS.

27. A control system for a switch mode power supply (SMPS), the control system having a demand input to receive a demand signal indicating whether an output voltage of said SMPS is above or below a desired value, and a drive output to provide a switching control signal to a switch controlling energy transfer between an input and an output of said SMPS during a power switching cycle of the SMPS, the control system further comprising:
a signal processor coupled to said demand input and to said drive output to control said drive output responsive to said demand signal to regulate said output voltage at said desired value; wherein
said switching control signal comprises a plurality of pulses, said signal processor being configured to vary at least one of a width and a frequency of said pulses to regulate said output voltage; and wherein said signal processor is further configured to vary said at least one of pulse width and pulse frequency between discrete values such that at least some of said discrete values lack a common factor.

28. A control system as claimed in claim 27 wherein said SMPS has a clock, and wherein said discrete values are defined in terms of a number of cycles of said SMPS clock.

29. A control system as claimed in claim 27 wherein adjacent ones of said discrete levels lack a common factor.

30. A control system as claimed in claim 27 further comprising storing values of at least one of a pulse width and a pulse period to define said discrete values.

31. A switch mode power supply incorporating the control system of claim 21.

32. A method of controlling a switch mode power supply (SMPS), the method comprising:
inputting a demand signal indicating whether an output voltage of said SMPS is above or below a desired value; and
outputting a switching control signal for controlling a switch controlling energy transfer between an input and an output of said SMPS during a power switching cycle of the SMPS;
wherein said switching control signal comprises a succession of pulses, the method further comprising:
modulating both a pulse frequency and a pulse width of said succession of pulses responsive to said demand signal to regulate said output voltage.

33. A method of controlling a switch mode power supply (SMPS), the method comprising:
inputting a feedback signal dependent upon an output level of the SMPS; and
outputting a control signal for controlling an output power of said SMPS;
the method further comprising:
controlling said SMPS to operate at a selected one of a plurality of substantially logarithmically spaced power levels.

34. A method of controlling a switch mode power supply (SMPS), the method comprising:
inputting a demand signal indicating whether an output voltage of said SMPS is above or below a desired value; and
outputting a switching control signal for controlling a switch controlling energy transfer between an input and an output of said SMPS during a power switching cycle of the SMPS;
wherein said switching control signal comprises a succession of pulses, the method further comprising:
varying at least one of a width and a frequency of said pulses to regulate said output voltage, said varying comprising varying between discrete values such that at least some of said discrete values lack a common factor.

35. A control system for a switch mode power supply configured to operate in accordance with the method of claim 32.

36. A switch mode power supply incorporating the control system of claim 27.
